(19) United States
(12) Patent Application Publication
(10) Pub. No.: US 2015/0083650 A1
(43) Pub. Date: Mar. 26, 2015

(54) Circulation apparatus for agricultural and fishery production and irrigation

(71) Applicants: Yi-Sheng Huang, Pingtung (TW); Tseng-Yu Lin, Kaohsiung (TW)

(72) Inventors: Yi-Sheng Huang, Pingtung (TW); Tseng-Yu Lin, Kaohsiung (TW)

(21) Appl. No.: 14/037,373

(22) Filed: Sep. 26, 2013

(51) Int. Cl. C02F 1/00

(52) U.S. Cl. CPC C02F 1/004; C02F 1/006; C02F 2103/22
USPC 210/195.1

(57) ABSTRACT

A circulation apparatus for agricultural and fishery production and irrigation is provided with a water supply device; a production device; a filter device; an irrigation device; a water storage device; and pipes for connecting the water supply device, the production device, the filter device, the irrigation device, and the water storage device together. The water filter device is filtered and sterilized, and outputs to the irrigation device to supply an irrigation water source for agricultural uses. Excess of the irrigation water source outputs to the water storage device for storage, and flows into the water supply device again or the irrigation device so as to make the irrigation water source to be continuously re-circulated and reused among the water supply device, the production device, the filter device, the irrigation device, and the water storage device.

### BACKGROUND OF THE INVENTION

1. Field of the Invention

The invention relates to circulation apparatuses, and more particularly to a circulation apparatus for the agricultural and fisheries production and irrigation, which makes the water source to be continuously circulated, filtered, sterilized and reused among the water supply device, the production device, the filter device, the irrigation device and the water storage device, and not only can provide a water source for the agriculture and fisheries production, but also can significantly reduce the consumption of water resources and increases the effectiveness of the environmental protection.

2. Description of Related Art

Water is the source of life and is used in a wide spectrum of applications. For example, in the case of fisheries production, fish must live in the water because their gills can utilize the water flow to filter oxygen. Therefore, the fisheries production must provide sufficient volume of water. Besides the sufficient water volume, the cleanliness of the water is also very important. The fish excrement is retained in the water and, after a prolonged accumulation, the cleanliness of the water reduces. Eventually, the water breeds bacteria that affect the development of the fish. As a result, to maintain the water quality is important and it is required to change fresh water frequently. The disposed water can not be recycled and reused. Therefore, to fulfill the demand of water volume and water quality, water resources are consumed in a huge scale. For regions with water resource shortage, fisheries production can hardly survive.

Furthermore, in additional to the huge demand of water in the fisheries production, the water usage volume in the agriculture irrigation also can not be ignored where the demand in water quality is even higher. Therefore, in summary, when the water resource is limited, how to apply the effect of recycling water to repeatedly recycle and reuse water resources, becomes an urgent task in reducing the consumption of water resources.

Thus, the need for improvement still exists.

### SUMMARY OF THE INVENTION

It is therefore one object of the invention to provide a circulation apparatus for agricultural and fishery production and irrigation, comprising a water supply device; a production device; a filter device; an irrigation device; a water storage device; and a plurality of pipes for connecting the water supply device, the production device, the filter device, the irrigation device, and the water storage device together; wherein the water filter device is filtered and sterilized, and outputs to the irrigation device to supply an irrigation water source for agricultural uses; and excess of the irrigation water source outputs to the water storage device for storage, and flows into the water supply device again or the irrigation device so as to make the irrigation water source to be continuously re-circulated and reused among the water supply device, the production device, the filter device, the irrigation device, and the water storage device.

The above and other objects, features and advantages of the invention will become apparent from the following detailed description taken with the accompanying drawings.

### BRIEF DESCRIPTION OF THE DRAWINGS

FIG. 1 is a schematic diagram of a circulation apparatus of the invention;

FIG. 2 is a schematic diagram of the production device of the invention;

FIG. 3 is a schematic sectional view of the production device of the invention; and

FIG. 4 is a schematic diagram of the irrigation device installed above the production device of the invention.

### DETAILED DESCRIPTION OF THE INVENTION

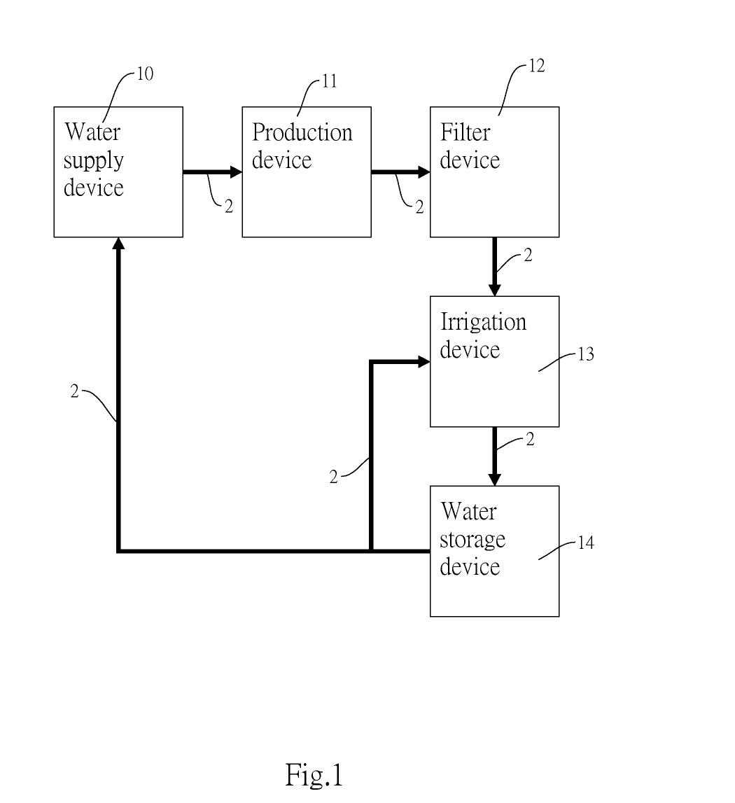

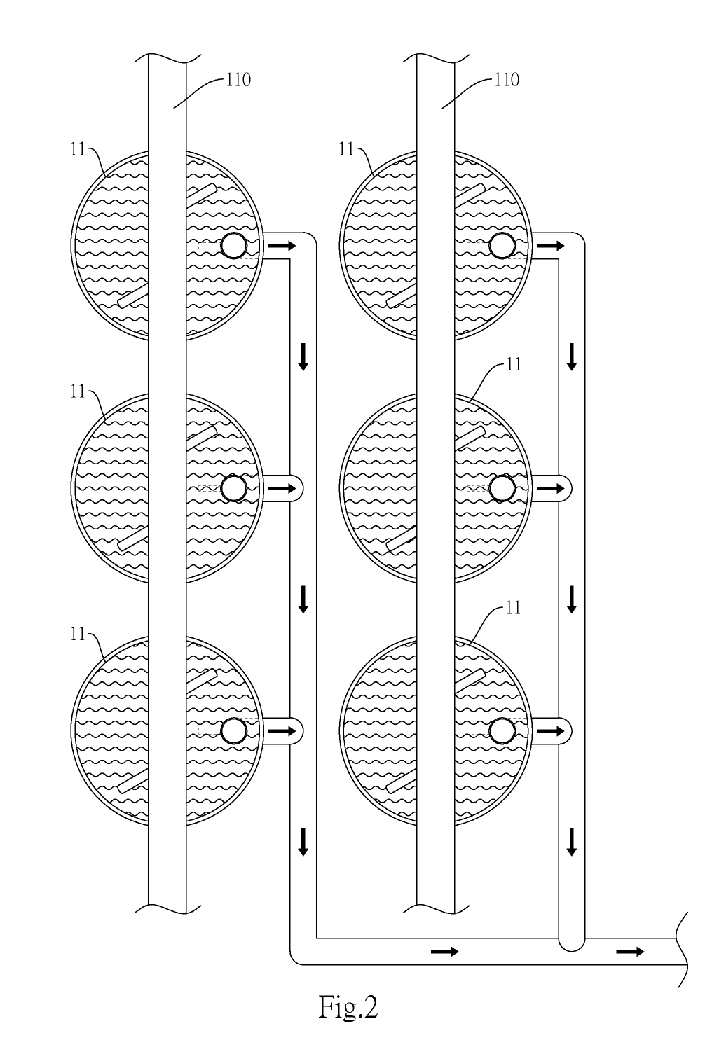

Referring to FIGS. 1 to 3, a circulation apparatus for agricultural and fishery production and irrigation in accordance with the invention comprises a water supply device 10, a production device 11, a filter device 12, an irrigation device 13, and a water storage device 14 connected by a pipeline 2. The number of production device 11 can be increased according to the requirements (as shown in FIG. 2).

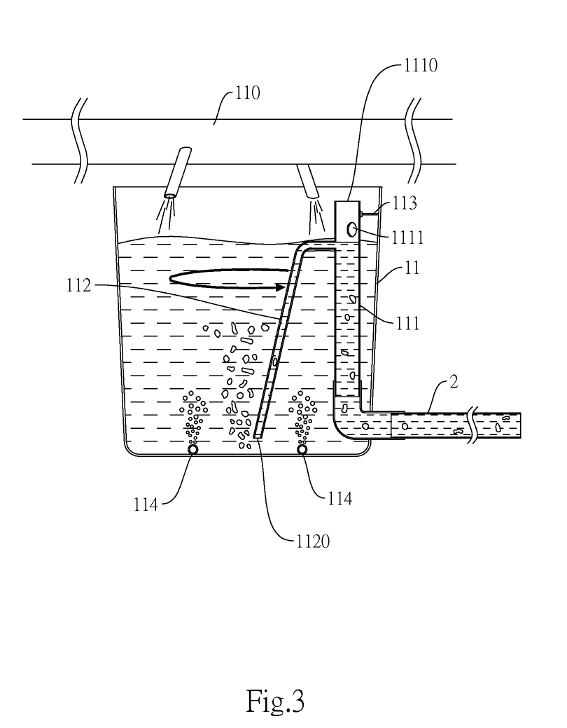

The water supply device 10 can provide fresh water or salt water depending on the produced species of organism in the production device 11 and the crop species irrigated by the irrigation device 13. The production device 11 produces a variety of aquatic organisms using the fresh water or the salt water (as shown in FIG. 3). The impurities and excrement generated by the aquatic organisms in the production device 11 are processed by the components of the production device 11. The water injection pipe 110 is positioned above the water surface that can inject water bi-directionally. The conduit 111 is partially submerged under the water surface. The side-branched pipe 112 is connected to the conduit. The support frame 113 connects the conduit 111 and the inner wall of the production device 11. The aeration pipe 114 is positioned in the bottom of the production device 11. The conduit 111 has a top opening 1110 and a side opening 1111 above the water surface. The side-branched pipe 112 has a bottom opening 1120 under the water surface. The support frame 113 is for securing the positions of the conduit 111 and the side-branched pipe 112. Accordingly, when the production device 11 is in operation, the water injection pipe 110 injects water to the water surface of the production device 11 causing the water in the production device 11 to move in a swirling motion to gather the impurities and excrement in the water. At this moment, the water level of the production device 11 is higher than that of the filter device 12 forcing the water in the production device 11, due to the effect of the level difference and the pressure difference, bringing the water containing impurities and excrement to be transported to the conduit 111 and in the filter device 12 accordingly in sequence through the bottom opening 1120 of the side-branched pipe 112 so as to clean the excrement and the impurities. At the same time, to utilize the effect of the level difference and the pressure difference can reduce the required devices and electricity consumption for charging the water level. In addition, when the conduit 111 is blocked by the impurities or excrement, the water level in the conduit 111, which continuously elevates, can be released through the side opening 1111 and returned into the production device 11. Besides, the aeration pipe 114 described previously can add oxygen to the water and increase the dissolved oxygen level in the water.

According to the explanation described above, the filter device 12 filters the water source output from the production device 11 and can filter the impure particles of 5-40 μm in diameter initially. In addition, the filter device 12 is equipped with the biological filter bed (not shown in the figure) such that the odoriferous substances and organic pollutants in the water are decomposed into carbon dioxide, water or inorganic acid salts using the microbes and the water source is cleansed.

Next, the filter device 12 outputs the filtered water source to the irrigation device 13 and the irrigation device 13 irrigates the agricultural crops with the cleaned water. When the irrigation water source is excessive, the excess of clean water is then output to the water storage device 14. The water storage device 14 is placed with algae therein (not shown in the figure) for the main purpose of utilizing the algae to perform photosynthesis and to increase the dissolved oxygen level in the water. The stilled water with high dissolved oxygen level then is output to the water supply device 10 for recirculation and reuse, or is output directly to the irrigation device 13 to provide a cleaner irrigation water source for agricultural use.

Based on explanation described above, the circulation apparatus for the agricultural and fishery production and irrigation causes the water source to be continuously filtered, circulated and reused among the water supply device 10, the production device 11, the filter device 12, the irrigation device 13, and the water storage device 14, and not only can be used in the agricultural and fishery production, but also can significantly reduce the consumption of water resources and increase the effectiveness of the environmental protection.

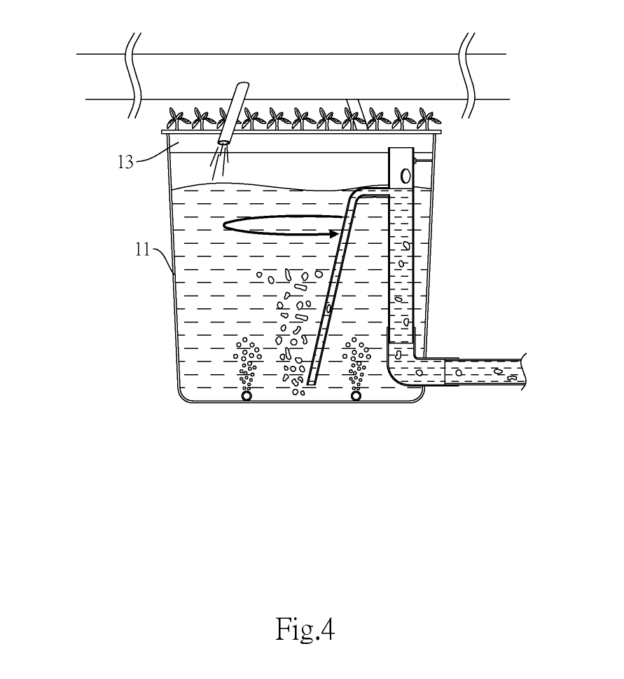

Referring to FIG. 4, the irrigation device 13 can be installed above the production device 11. The irrigation device 13 for potted plants, for example, can reduce the occupied space and can be used for planting purpose. Thus, the invention can become the home-based circulation apparatus of the agricultural and fishery production and irrigation and is free from the spatial restriction.

While the invention has been described in terms of preferred embodiments, those skilled in the art will recognize that the invention can be practiced with modifications within the spirit and scope of the appended claims.

What is claimed is:

1. A circulation apparatus for agricultural and fishery production and irrigation, comprising:
a water supply device;
a production device;
a filter device;
an irrigation device;
a water storage device; and
a plurality of pipes for connecting the water supply device, the production device, the filter device, the irrigation device, and the water storage device together;
wherein the water filter device is filtered and sterilized, and outputs to the irrigation device to supply an irrigation water source for agricultural uses; and excess of the irrigation water source outputs to the water storage device for storage, and flows into the water supply device again or the irrigation device so as to make the irrigation water source to be continuously re-circulated and reused among the water supply device, the production device, the filter device, the irrigation device, and the water storage device.

2. The circulation apparatus of claim 1, wherein the water supply device provides either fresh water or salt water.

3. The circulation apparatus of claim 2, wherein the production device is provided with a bi-directional water injection pipe positioned above the water surface, a conduit partially submerged under the water surface, a side-branched pipe connected to the conduit, a support frame connected to the conduit and an inner wall of the production device, and an aeration pipe positioned in a bottom of the production device; wherein the conduit has a top opening and a side opening above the water surface; wherein the side-branched pipe has a bottom opening under the water surface; and wherein when the water injection pipe injects water to the water surface of the production device, the water in the production device moves in a swirling motion gathering the impurities and excrement in the water to easily output through the conduit to the filter device.

4. The circulation apparatus of claim 3, wherein the filter device filters impure particles of 5-40 μm in diameter and is further provided with a biological filter bed to decompose the harmful substances into carbon dioxide, water or inorganic acid salts using the microbes.

5. The circulation apparatus of claim 1, wherein the water storage device is placed with algae to perform photosynthesis in order to increase the dissolved oxygen level in the water.

6. The circulation apparatus of claim 4, wherein the water storage device is placed with algae to perform photosynthesis in order to increase the dissolved oxygen level in the water.

7. The circulation apparatus of claim 1, wherein the irrigation device is installed above the production device to reduce the occupied space and is used for planting purpose.

8. The circulation apparatus of claim 3, wherein the irrigation device is installed above the production device to reduce the occupied space and is used for planting purpose.
